(19) United States
(12) Patent Application Publication
(10) Pub. No.: US 2017/0155961 A1
(43) Pub. Date: Jun. 1, 2017

(54) METHOD, DEVICE AND SYSTEM FOR PRESENTING EVENT INFORMATION

(71) Applicants: Le Holdings (Beijing) Co., Ltd., Beijing (CN); LeTV Sports Culture Develop (Beijing), Co., Ltd., Beijing (CN)

(72) Inventors: Dongchen HUO, Beijing (CN); Zhenhua YAN, Beijing (CN); Ranyang WANG, Beijing (CN)

(21) Appl. No.: 15/245,308

(22) Filed: Aug. 24, 2016

Related U.S. Application Data
(63) Continuation of application No. PCT/CN2016/082622, filed on May 19, 2016.

(30) Foreign Application Priority Data
Nov. 26, 2015 (CN) 201510845406.4

(51) Int. Cl. H04N 21/482; H04N 21/81; H04N 21/431; H04N 21/84

(52) U.S. Cl. CPC H04N 21/482; H04N 21/84; H04N 21/8126; H04N 21/431

(57) ABSTRACT

Disclosed are a method, a device and a system for presenting event information. The method includes: sending to a server end a time point value when a calendar interface of events is logged into; receiving event information returned by the server end, wherein the event information is information of events broadcasting on the day of the time point, and the event information includes content summary information of the events, broadcast time period information, and broadcast state information of the events at the time point; searching an event broadcasting in a time period which the time point falls within, and determining the found event as a target event; and displaying content summary information and broadcast state information of the target event at a current time node corresponding to the time point in a timeline.

### CROSS REFERENCE TO RELATED APPLICATIONS

This application is a continuation of International Application No. PCT/CN2016/082622, filed on May 19, 2016, which is based upon and claims priority to Chinese Patent Application No. 201510845406.4, filed on Nov. 26, 2015, the entire contents of which are incorporated herein by reference.

### TECHNICAL FIELD

The present disclosure generally relates to electrical communication technologies, and more particularly to a method, a device and a system for presenting event information.

### BACKGROUND

Sports competitions are social activities which, through basic physical or intelligence activities, based on principles such as human growth and development, skill formation and human body function improvements, aim to arrive at promotion of full development, improvement of human body performance, enhancing of health and changes of lifestyle. With the development of sports competitions, people have paid increasingly more attentions on sports events, and have enquired information on sports events more frequently than ever. Establishing a list showing relationship between events times and sports items is convenient for users to enquire relevant information of sports events. When users view information on events, they need to search available event information according to the current time. Such displaying approach is not intuitive enough, and thus users cannot quickly find information about the competitions at the current time point.

In order to solve the problem that users cannot quickly find information about the events at the current time point, a conventional technology provides a method for displaying event information in a timeline. The method determines the positions where events are displayed in the timeline according to the starting times of events. Then, users can quickly find information about the events at the current time point. However, when users find events which are on the air at the current time, they can only determine whether there is a live broadcast of events according to the starting times and durations of events, and they need to perform determinations on a plurality of events. Thus it is likely that users may miss some events, and they cannot find information about all the events which are on the air at the current time.

### SUMMARY

The present disclosure provides a method, a device and a system for presenting event information, which are capable of solving the problem of missing information of events which are currently on the air.

In order to solve the above problem, in a first aspect, embodiments of the present disclosure provide a method for presenting event information, implemented by a client, including:

sending to a server end a time point value when a calendar interface of events is logged into;

receiving event information returned by the server end, wherein the event information is information of events broadcasting on the day of the time point, and the event information includes content summary information of the events, broadcast time period information, and broadcast state information of the events at the time point;

searching an event broadcasting in a time period which the time point falls within, and determining the found event as a target event; and

displaying content summary information and broadcast state information of the target event at a current time node corresponding to the time point in a timeline.

In a second aspect, embodiments of the present disclosure provide an electronic device, including:

at least one processor; and

a memory communicably connected with the at least one processor for storing instructions executable by the at least one processor, wherein execution of the instructions by the at least one processor causes the at least one processor to perform any methods for presenting event information mentioned by embodiments of the present disclosure.

In a third aspect, embodiments of the present disclosure provide a non-transitory computer-readable storage medium storing executable instructions that, when executed by an electronic device, cause the electronic device to perform any methods for presenting event information mentioned by embodiments of the present disclosure.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for presenting event information in accordance with some embodiments;

FIG. 2 is a flowchart illustrating a method for presenting event information in accordance with some embodiments;

FIG. 3 is a block diagram illustrating a structure of a device for presenting event information in accordance with some embodiments;

FIG. 4 is a block diagram illustrating a structure of a device for presenting event information in accordance with some embodiments;

FIG. 5 is a block diagram illustrating a system for presenting event information in accordance with some embodiments;

FIG. 6 is a block diagram illustrating a device for presenting event information in accordance with some embodiments; and

FIG. 7 is a block diagram illustrating an electronic device in accordance with some embodiments.

### DETAILED DESCRIPTION

In order to make objectives, technical solutions and advantages of embodiments of the present disclosure more clear, technical solutions in embodiments of the present disclosure will be described clearly and completely with reference to drawings of embodiments of the present disclosure. It should be noted that the following embodiments are illustrative only, rather than limiting the scope of the disclosure.

In order to avoid missing of information on events which are currently on the air, embodiments of the present disclosure provide a method for presenting event information. As shown in Fig., the method can include the following steps.

In step 101, a time point value when a calendar interface of events is logged into is sent to a server end.

A user can log into a calendar interface of events to view information on events which are currently on the air. When the user logs into the calendar interface of events, a client automatically sends the time point when the calendar interface of events is logged into to a server end. The time point value indicates all time information when the user logs into the calendar interface of events, which may include the year, the month and the day, or may include the year, the month, the day and the time point, or even more accurate time unit may be added. The time point can be measured to the hour, the minute, the second, or the time unit smaller than the second. The time information such as the starting times and durations of competitions are mostly measured to the second, and thus in order to ensure the accuracy of the time information, the time point can be measured to the second. The embodiments of the present do not impose specific limitations on the accuracy of the time point.

In 102, event information returned by the server end is received.

The server end continuously updates data information of events, and this ensures that the event information returned by the server end includes the information of all the events broadcasting on the day of the time point when the user logs into the calendar interface of events. The server end needs to update the event information for once each day at least. The server end can select to update the event information with a fixed time interval, or can update the event information in the same frequency with that of the event information provider. Embodiments of the present disclosure do not impose specific limitations on the update frequency of the event information at the server end. For some event information, even after determined, the starting time or duration of the events may need to be readjusted due to some unexpected situations, and thus the server end needs to update the event information in time to ensure the accuracy of the returned event information.

The returned event information includes all the events which are started on the day of the time point when the user logs into the calendar interface of events. The day of the time point when the user logs into the calendar interface of s events refers to a corresponding date in the time information when the user logs into the calendar interface of events, i.e., the day and the year. The event information includes content summary information of events, broadcast time period information, and broadcast state information of the events at the time point when the user logs into the calendar interface of events. The content summary information can include the starting times, the names and the types of the events, information about whether the events are between two sides, whether there is a live broadcast, whether there is a replay, whether there are event highlights.

The names of events refer to a generic term describing the competitions, for example, the World Cup, the NBA, the French football league. The types of the events refer to the competition items, for example, football, basketball, boxing, or the like. The event information returned by the server end indicates the specific striating time, the names and the types of the events in the content summary information.

The information about whether the events are between two sides indicates whether the events are adversary competitions between two sides, for example, football games and table tennis competitions belong to adversary competitions, and diving competitions and Marathon do not belong to adversary competitions. In addition to video live broadcast, people can gain information about events by live broadcast by means of texts and images. Thus, the presentation approach of the event information is depending on whether there is live broadcast. Replay refers to repeatedly playing of some wonderful shots during competitions. Event highlights refer to collections of wonder shots during competitions. In the content summary information returned by the server end, whether the competitions are between two sides, whether there is a live broadcast, whether there is a replay, whether there are event highlights can be indicated by state information characters which represent yes or no. Generally, “0” can be used to represent “no”, and “1” can be used to represent “yes”. Also, other characters can be used to represent the above information. Embodiments of the present disclosure do not impose specific limitations on the state information characters representing yes or no.

The broadcast state information can be determined jointly by the starting times of competitions, the ending times of competitions and the time point when the user logs into the calendar interface of events. The more accurate the time point when the calendar interface of events is logged into, the more accurate the returned broadcast state information will be. The broadcast state information can include three types of broadcast states, i.e., “not started”, “being broadcast”, and “ended”. If the time point when the user logs into the calendar interface of events is between the starting time and the ending time of a competition, the broadcast state information of the competition can be determined as “being broadcast”. If the time point when the user logs into the calendar interface of events is before the starting time of a competition, the broadcast state information of the competition can be determined as “not started”. If the time point when the user logs into the calendar interface of events is after the ending time of a competition, the broadcast state information of the competition may be determined as “ended”. The server can return state information characters representing the broadcast state information. Generally, “0” can be used to represent “not started”, “1” can be used to represent “being broadcast”, and “2” can be used to represent “ended”. Also, other characters can be used to represent the broadcast state information, and embodiments of the present disclosure do not impose specific limitations on the state information characters representing the broadcast state information.

The broadcast time period information refers to the time periods which the competitions fall within. The granularity for dividing time periods can be preset. A value in a certain time indicating a time unit which is in conformity with the preset granularity can be selected and marked as the time period which the time falls within. As an example, if a certain time is Nov. 15, 2015, 9:30 and the preset granularity is “hour”, then the value “9” which is in the same time unit with the “hour” is selected, and “9” is the time period which the time falls within. Then, the information about the events is displayed at a position corresponding to “9”. The events belong to the same time period are displayed at the position corresponding to the time period. The granularity for dividing time periods in the broadcast time period information is irrelevant to the accuracy of the time point when the user logs into the calendar interface of sports events. The granularity for dividing time periods is related to the display position of the events in the interface, and the accuracy of the time point when the user logs into the calendar interface of events is related to the broadcast states of the events. The broadcast time period information can be determined jointly by the starting times of competitions, the broadcast state information and the time point when the user logs into the calendar interface of sport events. If the broadcast state information of a competition is “not started” or “ended”, the broadcast time period information of the competition can be determined according to the starting time of the competition. If the broadcast state information of a competition is “being broadcast”, the broadcast time period information is in conformity with the time point when the user logs into the calendar interface of events.

As an example, among three competitions on Nov. 15, 2015, the first competition is from 10:10 to 11:40, the second competition is from 11:30 to 13:00, and the third competition is from 13:20 to 14:20. The time point when the user logs into the calendar interface of the events is 12:10. If the preset granularity is “hour”, then the time period which the time point when the user logs into the calendar interface of the events falls within is the time period indicated by “12”. The first competition is ended before the user logs into the calendar interface of events, and the broadcast time period information is “10”. The second competition is being broadcast when the user logs into the calendar interface of the events, and the broadcast time period information is “12” instead of “11”, which is the same as the time period which the time point when the user logs into the calendar interface of events falls within. The third competition is not started when the user logs into the calendar interface of events, the broadcast time period information is “13”.

The server end searches and calculates information about all events and returns the event information to the client.

In 103, an event broadcast in a time period which the time point falls within is searched, and the found event is determined as a target event.

The time period which the time point when the user logs into the calendar interface of events falls within is the target broadcast time period. From the broadcast time period information in the information about all events on the day returned by the server end, the event(s) in conformity with the target broadcast time period is(are) searched and determined as the target event(s). The target event(s) is(are) found according to time information, irrelevant of other information such as the number and types of events.

In 104, content summary information and broadcast state information of the target event are displayed at a current time node corresponding to the time point in a timeline.

There are a plurality of time nodes in the timeline which are time periods in the timeline divided according to preset granularity. The time duration represented by the timeline is a unit time duration which is one time unit greater than the preset granularity, and the preset granularity for dividing the time nodes is in conformity with the preset granularity for dividing the broadcast time periods. In the present embodiment, the preset granularity is one hour, and the time duration represented by the timeline is one day (i.e., 24 hours). The current time node is the time node when the user logs into the calendar interface of events. At the current time node in the timeline, the content summary information and broadcast state information of the target event which is found in the step 103 can be displayed. The code representing the broadcast state information returned by the server end is changed into corresponding information and contents. The displaying shall be convenient for users to view. For example, the content summary information and the broadcast state information can be displayed in the forms of texts or images, and embodiments of the present disclosure do not impose specific limitations on the display manner of the event information.

In the method for presenting event information provided by the present disclosure, the time point value when a calendar interface of events is logged into is sent to a server end, event information returned by the server end is received, an event broadcasting in a time period which the time point when the calendar interface of events is logged into falls within is found, and the found event information is displayed at a current time node in a timeline. As compared with prior technologies, embodiments of the present disclosure can display the information on the competitions which are currently on the air at the time node corresponding to the time point when the calendar interface of events is logged into. That is, it is the server end performs determinations on all the events (competitions), and thus information on the competitions which are currently on the air cannot be missed.

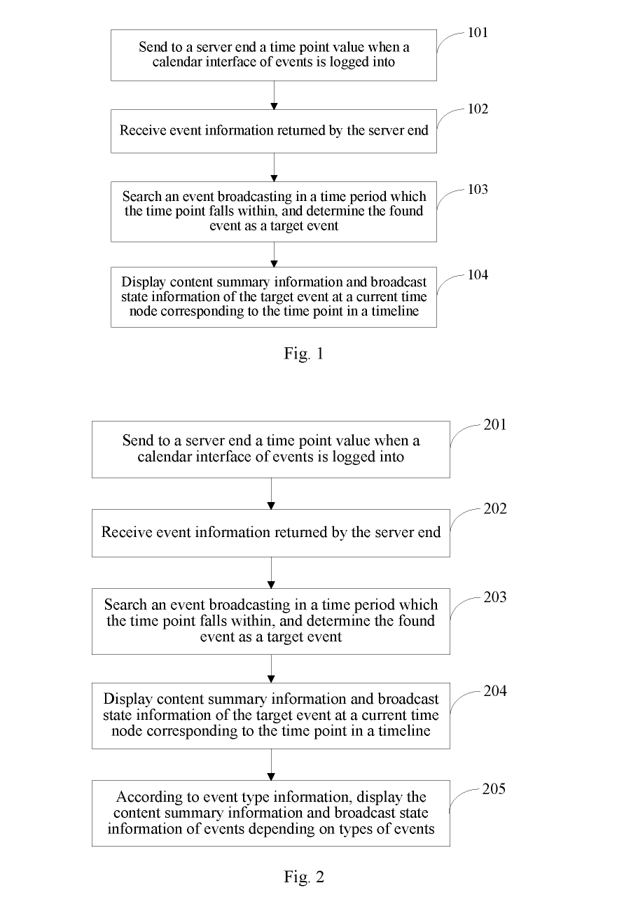

Further, as a further detailed example of FIG. 1, embodiments of the present disclosure provide another method for presenting event information. As shown in FIG. 2, the method can include the following steps.

In 201, a time point when a calendar interface of events is logged into is sent to a server end.

In 202, event information returned by the server end is received.

The content summary information and broadcast state information included in the event information is the same as that in the descriptions regarding step 102, and repeated descriptions are omitted.

The broadcast time period information is included in the event information. The preset granularity for dividing broadcast time periods can be set according to users' actual requirements. The minimum unit of the preset granularity may be a day, an hour, a minute, or a second, and the preset granularity can be an integral multiple of the minimum unit of the preset granularity. In the present embodiment, the magnitude of the preset granularity is not specifically defined.

Depending on different preset granularity units, the server end can return different event information. The event information returned by the server end includes information about all events within a time duration which is one time unit greater than the preset granularity unit. For example, if the preset granularity unit is “hour”, the event information returned by the server end is information about all the events in the day when a user logs into the calendar interface of sport events. If the preset granularity unit is “day”, the event information returned by the server end is information about all the events in the month when the user logs into the calendar interface of sport events. As an example, if a user logs into the calendar interface of sports event on Nov. 15, 2015, 11:51, and the preset granularity unit is “hour”, the server end returns the information about all the events on Nov. 15, 2015. If a user logs into the calendar interface of sports event on Nov. 15, 2015, 11:51 and the preset granularity unit is “day”, the server end returns the information about all the events in the month of November, 2015.

The broadcast time period information is a value in the time point when the user logs into the calendar interface of events, and the value corresponds to a time which is one time unit greater than the preset granularity unit.

In order to ensure the integrity of the data as inquired by users returned by the server end, the server ends stores information about all events within a certain time range. The certain time range can be determined according to the time range set in the front end within which users are allowed to enquire events. The present embodiment does not impose specific limitations on the time range within which users are allowed to enquire events.

In 203, an event broadcasting in a time period which the time point falls within is searched, and the found event is determined as a target event.

The broadcast time period information of all the target events is the same. The searching of events can include searching events which are currently broadcast in the time period corresponding to the time point when the user logs into the calendar interface of events, and events which have been started before the end of the current time node. For example, two competitions after the time point (for example, Nov. 15, 2015) when the user logs into the calendar interface of sport events are searched, the first competition is from 11:30 to 13:30 and the second competition is from 12:20 to 13:20, and the time point when the user logs into the calendar interface of events is 12:10. Then, the time period corresponding to the log-in time of the user is the time period indicated by “12”; the broadcast time period information of the first competition is “12” and the first competition is currently broadcast; the broadcast time period information of the second competition is “12”; thus, the first and second competitions are the target events.

In 204, content summary information and broadcast state information of the target event(s) are displayed at a current time node corresponding to the time point in a timeline.

The current time node is used to display a broadcast time period(s) corresponding to the target event(s). When the user logs into the calendar interface of events, the current time node is determined according to the log-in time of the user, and the content summary information and broadcast state information of the target events(s) are displayed at the current time node. The current time node varies depending on the time period when the user performs inquiry. In order to facilitate the user to enquire event information at different time nodes, the current time node and other time node can be distinguishingly displayed. For example, the distinguishing display can be realized by changing colors of node icons, changing size of node icons, or highlighted node icons. The present embodiment does not impose specific limitations on the distinguishing display between the current time node and other time nodes.

Due to the difference in the event information returned by the server end, there may be or not be competition information in the timeline. In order to increase users' inquiry efficiency and improve user experience, the nodes having competition information and the nodes having no competition information can be distinguishingly displayed as well. For example, the nodes can be distinguished by providing clickable or non-clickable settings. The present embodiment does not impose specific limitations on the manner for distinguishing the nodes having competition information and those having no competition information. However, the manner for distinguishing the nodes having competition information and those having no competition information shall be different from the manner for distinguishing the current time node and other time nodes, so as to realize different distinguishing of nodes under different situations.

When one or more of other time nodes in the timeline are clicked, content summary information and broadcast state information of events at the other time nodes can be displayed according to the broadcast time period information. Specifically, when one of the other time nodes is clicked, the event information at the one of the other time nodes corresponding to the displayed broadcast time period information is the event information returned back when the user logs into the calendar interface of events. That is, every time when the user logs into the calendar interface of events, event information is returned for once, and the broadcast time period information in the event does not change as the selected time node changes.

In the front-end display interface, the size of the display region is limited, and thus it is needed to determine the maximum number of events which can be displayed on each page according to the size of the region and the information display manner. The present embodiment does not impose specific limitations on the display manner of the event information and the maximum number of events which can be displayed on each page.

If the number of the events which are needed to be displayed at one time node is greater than the maximum number of events which can be displayed on each page, the events at the time node can be displayed at separate pages. If the number of the events which are needed to be displayed at one time node is smaller than the maximum number of events which can be displayed on each page, the event information corresponding to the next time node can be displayed sequentially, until the maximum number of events which can be displayed on one page are displayed on the page corresponding to the time node.

In 205, according to the event type information, the content summary information and broadcast state information of events are displayed depending on types of events.

The event information returned by the server end can include event type information. The events can be classified according to the event type information. According to the event type information selected by the user, events meeting the user's requirements can be selected from the event information returned by the server end according to the user's log-in to the calendar interface of events, and the content summary information and broadcast state of events can be displayed. As an example, if the event information returned by the server end includes competition items such as football, basketball, and diving, and the user selects the football, event information corresponding to football is displayed at respective nodes in the timeline.

Also, other contents in the event information, except time information, can be used as filtering conditions to display event information according to types.

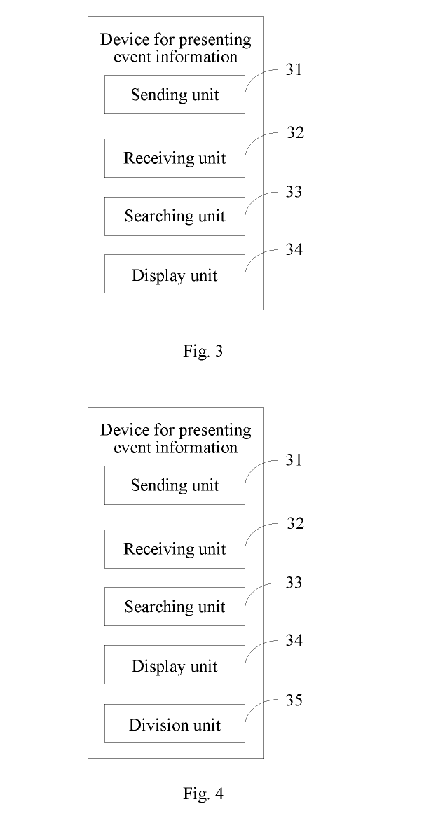

Further, embodiments of the present disclosure provide a device for presenting event information to implement the above methods in FIG. 1 or 2. The embodiments of the device correspond to the previous embodiments of methods and can implement all the contents in the embodiments of methods. For convenience in reading, only summary descriptions are made on the embodiments of device, and detailed contents related to the embodiments of methods will not be repeated here. As shown in FIG. 3, the device can include a sending unit 31, a receiving unit 32, a searching unit 33, and a display unit 34.

The sending unit 31 is configured to send to a server end a time point value when a calendar interface of events is logged into.

When a user logs into the calendar interface of sport events, a client automatically sends the time point when the calendar interface of sport events is logged into to a server end.

The receiving unit 32 is configured to receive event information returned by the server end, wherein the event information is information of events broadcasting on the day of the time point which is sent by the sending unit 31, and the event information includes content summary information of the events, broadcast time period information, and broadcast state information of the events at the time point which is sent by the sending unit 31.

The server end continuously updates data information of events, and this ensures that the event information returned by the server end includes the information of all the events broadcast on the day of the time point when the user logs into the calendar interface of sport events. The server ends needs to update the event information for once each day. The server end may select to update the event information at a fixed time interval, or may update the event information in the same frequency with that of the event information provider. Embodiments of the present disclosure do not impose specific limitations on the update frequency of the event information at the server end. For some event information, even after determined, the starting time or duration of the competitions may need to be readjusted due to some unexpected situations, and thus the server end needs to update the event information in time to ensure the accuracy of the returned event information.

The returned event information includes all the events which are started on the day of the time point when the user logs into the calendar interface of sport events. The event information includes content summary information of events, broadcast time period information, and broadcast state information of the events at the time point when the user logs into the calendar interface of events. The content summary information can include the starting times, the names and the types of the events, information about whether the competitions are between two sides, whether there is a live broadcast, whether there is a replay, whether there are event highlights. In the content summary information, whether the competitions are between two sides, whether there is a live broadcast, whether there is a replay, whether there are event highlights can be indicated by state information characters which represent yes or no, and the state information characters can be set at the server end which then sends the set state information characters. For the broadcast time period information and broadcast state information, the server end returns state information characters representing broadcast time period or broadcast state information.

The searching unit 33 is configured to search, from the event information received by the receiving unit 32, an event broadcasting in a time period which the time point falls within, and determine the found event as a target event.

The time period which the time point when the user logs into the calendar interface of events falls within is the target broadcast time period. From the broadcast time period information in the information about all events on the day returned by the server end, the event(s) in conformity with the target broadcast time period is(are) searched and determined as the target event(s).

The display unit 34 is configured to display content summary information and broadcast state information of the target event found by the searching unit 33 at a current time node corresponding to the time point in a timeline.

There are a plurality of time nodes in the timeline which are time periods in the timeline divided according to preset granularity. The time duration represented by the timeline is a unit time duration which is one time unit greater than the preset granularity, and the preset granularity for dividing the time nodes is in conformity with the preset granularity for dividing the broadcast time periods. The content summary information and broadcast state information of the target event are displayed at a current time node corresponding to the time point in the timeline.

Further, as shown in FIG. 4, the device can also include a division unit 35.

The division unit 35 is configured to, based on preset granularity, divide the timeline into a plurality of time periods, each of which corresponds to a time node, before the display unit 34 displays the content summary information and broadcast state information of the target event.

The display unit 34 is further configured to, when one or more of other time nodes in the timeline is clicked, display content summary information and broadcast state information of events corresponding to the one or more of the other time nodes according to the broadcast time period information.

The display unit 34 is further configured to distinguishingly display the current time node and other time nodes.

The event information received by the receiving unit 32 further includes event type information, and the display unit 34 is configured to, according to the event type information, display the content summary information and broadcast state information of events depending on types of events.

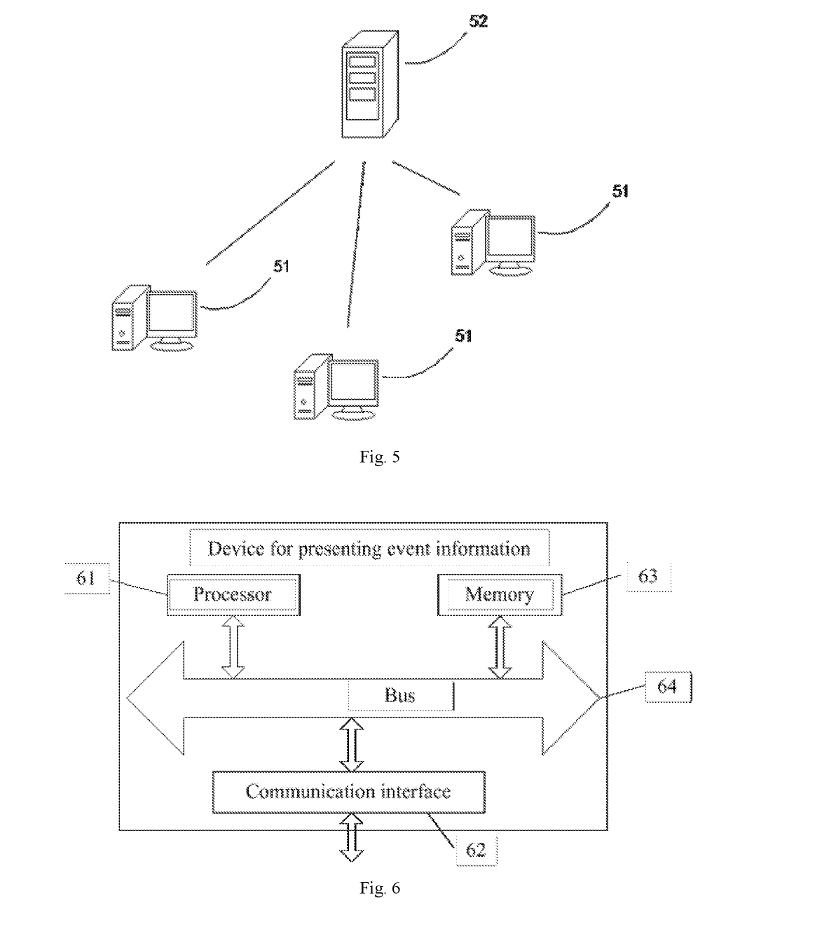

Further, another embodiment of the present disclosure provides a system for presenting event information to implement the above methods in FIG. 1 or 2. The embodiment of the system corresponds to the previous embodiments of methods and can implement all the contents in the embodiments of methods. For convenience in reading, only summary descriptions are made on the embodiment of the system, and detailed contents related to the embodiments of methods will not be repeated here. As shown in FIG. 5, the system can include a client 51 and a server end 52. The client 51 can include the device as shown in FIG. 3 or 4, or the client 51 may be a device independent of but have data interaction with the device as shown in FIG. 3 or 4 to realize all the functions of the device.

The client 51 is configured to send to the server end 52 a time point value when a calendar interface of events is logged into.

The server end 52 is configured to search content summary information and broadcast time period information of the events broadcasting on the day of the time point, determine broadcast state information of the events according to the temporal relationship between the time point and the broadcast time periods, and send the content summary information, the broadcast time period information and the broadcast state information to the client 51 as the event information.

The client 51 is further configured to search an event broadcast in a time period which the time point falls within, determine the found event as a target event, and display content summary information and broadcast state information of the target event at a current time node corresponding to the time point in a timeline.

In the device and system for presenting event information provided by embodiments of the present disclosure, the time point when a calendar interface of events is logged into is sent to a server end, event information returned by the server end is received, an event broadcasting in a time period which the time point when the calendar interface of events is logged into falls within is found, and the found event information is displayed at a current time node in a timeline. As compared with prior technologies, embodiments of the present disclosure can display the information on the competitions which are currently on the air at the time node corresponding to the time point when the calendar interface of sport events is logged into. That is, it is the server end performs determinations on all the events (competitions), and thus information on the competitions which are currently on the air cannot be missed.

It shall be noted that the functions of respective units or modules in the above devices for presenting event information according to embodiments of the present disclosure can be realized by hardware processors.

As an example, FIG. 6 is a block diagram showing a device for presenting event information according to an embodiment of the present disclosure. The device for presenting event information can include a processor 61, a communication interface 62, a memory 63 and a bus 64. The processor 61, the communication interface 62 and the memory 63 communicate with each other via the bus 64. The communication interface 62 may be used for information transmission between the server and a client. The processor 61 invokes logic instructions in the memory 63 to perform the following method: sending to a server end a time point valve when a calendar interface of events is logged into; receiving event information returned by the server end, wherein the event information is information of events broadcasting on the day of the time point, and the event information includes content summary information of the events, broadcast time period information, and broadcast state information of the events at the time point; searching an event broadcasting in a time period which the time point falls within, and determining the found event as a target event; and displaying content summary information and broadcast state information of the target event at a current time node corresponding to the time point in a timeline.

In addition, the logic instructions in the memory 63 may be implemented as software functional units which can be stored in a computer readable storage medium when sold or used as independent products. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium can include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for presenting event information mentioned by embodiments of the present disclosure.

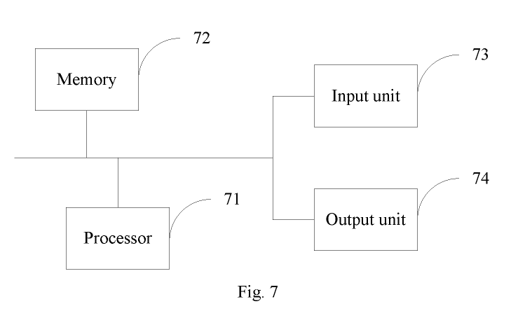

FIG. 7 is a block diagram of an electronic device which is configured to perform the methods for presenting event information according to an embodiment of the present disclosure. As shown in FIG. 7, the device includes: one or more processors 71 and memory 72. A processor 71 is showed in FIG. 7 for an example.

Device which is configured to perform the methods for presenting event information can also include: input unit 73 and output unit 74.

Processor 71, memory 72, input unit 73 and output unit 74 can be connected by BUS or other methods, and BUS connecting is showed in FIG. 7 for an example.

Memory 72 can be used for storing non-transitory software program, non-transitory computer executable program and modules as a non-transitory computer-readable storage medium, such as corresponding program instructions/modules for the methods for presenting event information mentioned by embodiments of the present disclosure (such as shown in FIG. 3, sending unit 31, receiving unit 32, searching unit 33, display unit 34). Processor 71 performs kinds of functions and data processing of the electronic device by executing non-transitory software program, instructions and modules which are stored in memory 72, thereby realizes the methods for presenting event information mentioned by embodiments of the present disclosure.

Memory 72 can include program storage area and data storage area, thereby the operating system and applications required by at least one function can be stored in program storage area and data created by using the device for presenting event information can be stored in data storage area. Furthermore, memory 72 can include high speed Random-access memory (RAM) or non-volatile memory such as magnetic disk storage device, flash memory device or other non-volatile solid state storage devices. In some embodiments, memory 72 can include long-distance setup memories relative to processor 71, which can communicate with the device for presenting event information by networks. The examples of said networks are including but not limited to Internet, Intranet, LAN, mobile Internet and their combinations.

Input unit 73 can be used to receive inputted number, character information and key signals causing user configures and function controls of the device for presenting event information. Output unit 74 can include a display screen or a display device.

The said module or modules are stored in memory 72 and perform the methods for presenting event information when executed by one or more processors 71.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer-readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for presenting event information, implemented by a client, comprising:
sending to a server end a time point value when a calendar interface of events is logged into;
receiving event information returned by the server end, wherein the event information is information of events broadcasting on the day of the time point, and the event information comprises content summary information of the events, broadcast time period information, and broadcast state information of the events at the time point;
searching an event broadcasting in a time period which the time point falls within, and determining the found event as a target event; and
displaying content summary information and broadcast state information of the target event at a current time node corresponding to the time point in a timeline.

2. The method according to claim 1, further comprising:
based on preset granularity, dividing the timeline into a plurality of time periods, each of which corresponds to a time node.

3. The method according to claim 1, further comprising:
when one or more of other time nodes in the timeline are clicked, displaying content summary information and broadcast state information of events corresponding to the one or more of the other time nodes according to the broadcast time period information.

4. The method according to claim 3, further comprising:
distinguishingly displaying the current time node and other time nodes.

5. The method according to claim 1, wherein the event information further comprises event type information;
wherein the method further comprises:
according to the event type information, displaying the content summary information and broadcast state information of events.

6. An electronic device, comprising:
at least one processor; and
a memory communicably connected with the at least one processor for storing instructions executable by the at least one processor,
wherein execution of the instructions by the at least one processor causes the at least one processor to:
send to a server end a time point value when a calendar interface of events is logged into;
receive event information returned by the server end, wherein the event information is information of events broadcasting on the day of the time point, and the event information comprises content summary information of the events, broadcast time period information, and broadcast state information of the events at the time point;
search, from the event information, an event broadcasting in a time period which the time point falls within, and determining the found event as a target event; and
display content summary information and broadcast state information of the target event at a current time node corresponding to the time point in a timeline.

7. The electronic device according to claim 6, wherein before displaying the content summary information and broadcast state information of the target event, the instructions are executed to cause the at least one processor to:
based on preset granularity, divide the timeline into a plurality of time periods, each of which corresponds to a time node.

8. The electronic device according to claim 6, wherein the instructions are executed to cause the at least one processor to:
when one or more of other time nodes in the timeline are clicked, display content summary information and broadcast state information of events corresponding to the one or more of the other time nodes according to the broadcast time period information.

9. The electronic device according to claim 8, wherein the instructions are executed to cause the at least one processor to:
distinguishingly display the current time node and other time nodes.

10. The electronic device according to claim 6, wherein the event information further comprises event type information; and
wherein the instructions are executed to cause the at least one processor to:
according to the event type information, display the content summary information and broadcast state information of events.

11. A non-transitory computer-readable storage medium storing executable instructions that, when executed by an electronic device, cause the electronic device to:
send to a server end a time point value when a calendar interface of events is logged into;
receive event information returned by the server end, wherein the event information is information of events broadcasting on the day of the time point, and the event information comprises content summary information of the events, broadcast time period information, and broadcast state information of the events at the time point;
search, from the event information, an event broadcasting in a time period which the time point falls within, and determining the found event as a target event; and
display content summary information and broadcast state information of the target event at a current time node corresponding to the time point in a timeline.

12. The non-transitory computer-readable storage medium according to claim 11, wherein before displaying the content summary information and broadcast state information of the target event, the executable instructions are executed to cause the electronic device to:
based on preset granularity, divide the timeline into a plurality of time periods, each of which corresponds to a time node.

13. The non-transitory computer-readable storage medium according to claim 11, wherein the executable instructions are executed to cause the electronic device to:
when one or more of other time nodes in the timeline are clicked, display content summary information and broadcast state information of events corresponding to the one or more of the other time nodes according to the broadcast time period information.

14. The non-transitory computer-readable storage medium according to claim 13, wherein the executable instructions are executed to cause the electronic device to:
distinguishingly display the current time node and other time nodes.

15. The non-transitory computer-readable storage medium according to claim 11, wherein the event information further comprises event type information; and
wherein the executable instructions are executed to cause the electronic device to:
according to the event type information, display the content summary information and broadcast state information of events.
